(19) United States
(12) Patent Application Publication
(10) Pub. No.: US 2023/0128539 A1
(43) Pub. Date: Apr. 27, 2023

(54) Systems And Methods For Providing Dynamic Fulfillment Defaults

(71) Applicant: Shopify Inc., Ottawa (CA)

(72) Inventors: Jin Xu, Markham (CA); Chiu Wai Cherry Chau, Markham (CA); Chelsea Singer, Montréal (CA); Ayesha Khan, Gatineau (CA); Shuang Xie, Ottawa (CA)

(21) Appl. No.: 17/507,793

(22) Filed: Oct. 21, 2021

(51) Int. Cl. G06Q 10/08; G06F 3/0482

(52) U.S. Cl. CPC G06Q 10/08345; G06Q 10/087; G06Q 10/0838; G06F 3/0482

(57) ABSTRACT

Systems and methods are described for providing dynamic guidance to purchasers using a fulfillment system to fulfill an order. The example systems can be configured to receive a request associated with an order and comprising an item identifier and an item quantity. The systems can estimate a request weight based on the item quantity and the item weight. The systems can also evaluate a request based on historical data associated with previous orders associated with the item identifier. The systems can select a dynamic default value based on the foregoing information and provide the dynamic default value for display to assist the purchaser.

### TECHNICAL FIELD

Embodiments of the technology relate generally to systems and methods for providing dynamic fullfillment defaults in connection with fulfilling an order using a fulfillment system.

### BACKGROUND

Commerce, and particularly electronic commerce, is increasingly supported by complex systems of order fulfillment. With the goal of efficiently and rapidly supplying purchased items to purchasers, fulfillment management systems are used to optimize the purchasing, gathering, and shipping of items to purchasers. Fulfillment management systems can include a fulfillment computing device or a commerce platform, such as an e-commerce platform, that facilitates a variety of sub-processes or services including the marketing of goods, the completion of orders, the payment for orders, and the gathering and shipping of purchased items. Given the large number of variables that can be associated with each of the foregoing sub-processes of a commerce platform, opportunities to create efficiencies in the fulfillment management system are desirable.

### SUMMARY

In one example embodiment, the present disclosure is directed to a computer-implemented method that can comprise receiving a request associated with an order and the request can comprise an item identifier and an item quantity. The method can include estimating a request weight for the request based on the item quantity and an item weight associated with the item identifier as well as evaluating the request based on historical data associated with previous orders. The previous orders can be associated with the item identifier of the request and the evaluation can generate a request evaluation. The method can select a dynamic default value for the request based on the item identifier, the item quantity, the request weight, and the request evaluation. Lastly, the method can provide an instruction to a fulfillment computing device to display the dynamic default value. Example embodiments of the foregoing method can include one or more of the following features.

In one example of the foregoing method, the dynamic default value can be one of a shipper identifier, a package size, a label value, and an insurance value. In another example of the foregoing method, the request evaluation can identify from the historical data one of: a manual override value, a most frequent value, an average value, and a most recent value; and the dynamic default value can be selected from the manual override value, the most frequent value, the average value, and the most recent value.

In another example of the foregoing method, evaluating the request based on the historical data associated with the previous orders can comprise identifying similar previous orders among the previous orders of the historical data, wherein the similar previous orders are associated with a same request weight as the request weight; identifying a previous value among the similar previous orders; and selecting the previous value as the dynamic default value. The previous value can be one of: a manual override value, a most frequent value, an average value, and a most recent value.

In yet another example of the foregoing method, evaluating the request based on the historical data associated with the previous orders can comprise identifying similar previous orders among the previous orders of the historical data, wherein the similar previous orders are associated with a same item identifier as the item identifier of the request and a same item quantity for the same item identifier as the item quantity of the request; identifying a previous value based on the similar previous orders; and selecting the previous value as the dynamic default value.

In yet another example, the foregoing method can comprise calculating a gross weight based on the request weight and a weight associated with a dynamic default package size; and providing an instruction to a purchasing computing device to display the dynamic default package size and the gross weight simultaneously. The method can comprise storing the dynamic default package size and the gross weight for batch processing of a plurality of additional requests for fulfillment comprising a same item identifier and a same item quantity. The foregoing method can include an instruction to the fulfillment computing device to display the dynamic default package size and the gross weight in a position selected based on an expected reading direction of a user interface language of the fulfillment computing device. The foregoing method can further comprise identifying a least expensive shipping option among the plurality of shipping options based on the gross weight; and providing an instruction to the fulfillment computing device to display the least expensive shipping option. The foregoing method can further comprise providing an instruction to the fulfillment computing device to display the least expensive shipping option simultaneously with the dynamic default package size and the gross weight.

The foregoing method can further comprise generating a label in response to a selection of a shipping option from among a plurality of shipping options; comparing the label to historical shipping insurance data; selecting a dynamic default shipping insurance for the request based on the item identifier, the item quantity, the request weight, the label, and the historical shipping insurance data; and providing an instruction to the fulfillment computing device to display the dynamic default shipping insurance.

In yet another example, the foregoing method can comprise receiving a tracking identifier associated with the request; applying a filter to the tracking identifier, determining a predicted tracking identifier format of the plurality of tracking identifier formats, and providing an instruction to the fulfillment computing device to display a predicted shipper identifier associated with the predicted tracking identifier format. In the foregoing method, the filter can comprise a location of a purchaser associated with the order and a location-based shipper associated with the location. As another example, in the foregoing method, the filter can comprise a most common shipper based on the historical data.

In another example embodiment, the present disclosure is directed to a fulfillment computing system that can include a memory and one or more processors. The memory can include instructions stored therein that, when executed by the one or more processors, can cause the one or more processors to perform operations comprising receiving a request associated with an order and comprising an item identifier and an item quantity. The operations can further comprise estimating a request weight for the request based on the item quantity and an item weight associated with the item identifier; as well as evaluating the request based on historical data associated with previous orders associated with the item identifier to generate a request evaluation; selecting a dynamic default value for the request based on the item identifier, the item quantity, the request weight, and the request evaluation; and providing an instruction to a fulfillment computing device to display the dynamic default value.

In another example embodiment, the present disclosure is directed to a non-transitory computer-readable medium having instructions stored thereon that, when executed by one or more computer processors, can cause the computer processors to perform certain operations. The operations can comprise receiving a request associated with an order and the request can comprise an item identifier and an item quantity. The operations can include estimating a request weight for the request based on the item quantity and an item weight associated with the item identifier as well as evaluating the request based on historical data associated with previous orders. The previous orders can be associated with the item identifier of the request and the evaluation can generate a request evaluation. The operations can select a dynamic default value for the request based on the item identifier, the item quantity, the request weight, and the request evaluation. Lastly, the operations can provide an instruction to a fulfillment computing device to display the dynamic default value. Example embodiments of the foregoing operations can include one or more of the following features.

The foregoing embodiment can include operations wherein the request evaluation identifies from the historical data one of: a manual override value, a most frequent value, an average value, and a most recent value; and wherein the dynamic default value is selected from the manual override value, the most frequent value, the average value, and the most recent value.

The foregoing embodiment can include operations wherein evaluating the request based on the historical data associated with the previous orders can comprise: identifying similar previous orders among the previous orders of the historical data, wherein the similar previous orders are associated with a same request weight as the request weight; identifying a previous value among the similar previous orders; and selecting the previous value as the dynamic default value.

The foregoing embodiment can include operations wherein evaluating the request based on the historical data associated with the previous orders can comprise: identifying similar previous orders among the previous orders of the historical data, wherein the similar previous orders are associated with a same item identifier as the item identifier of the request and a same item quantity for the same item identifier as the item quantity of the request; identifying a previous value based on the similar previous orders; and selecting the previous value as the dynamic default value.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of the disclosed systems and methods and therefore are not to be considered limiting of the scope of this disclosure. The principles illustrated in the example embodiments of the drawings can be applied to alternate systems and methods. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a block diagram of an e-commerce platform in accordance with an example embodiment of the disclosure.

FIG. 2 is an illustration of an administrator user interface of the e-commerce platform of FIG. 1 in accordance with an example embodiment of the disclosure.

FIG. 3 is a flow chart illustrating a method for dynamically providing guidance associated with an order in accordance with an example embodiment of the disclosure.

FIG. 4 is a flow chart illustrating a method for evaluating a request based on historical data in accordance with an example embodiment of the disclosure.

FIG. 5 is an illustration of a data structure in accordance with an example embodiment of the disclosure.

FIG. 6 is a flow chart illustrating a method for selecting dynamic default values in accordance with an example embodiment of the disclosure.

FIG. 7 is a flow chart illustrating another method for selecting dynamic default values in accordance with an example embodiment of the disclosure.

FIG. 8 is an illustration of a user interface providing dynamic guidance to a purchaser in accordance with an example embodiment of the disclosure.

FIG. 9 is an illustration of another user interface providing dynamic guidance to a purchaser in accordance with an example embodiment of the disclosure.

FIG. 10 is a flow chart illustrating a method for using a tracking identifier to provide dynamic guidance to a purchaser in accordance with an example embodiment of the disclosure.

FIG. 11 is an illustration of another user interface providing dynamic guidance to a purchaser in accordance with an example embodiment of the disclosure.

### DETAILED DESCRIPTION OF EXAMPLE EMBODIMENTS

The example embodiments discussed herein are directed to systems and methods for providing dynamic default guidance to a user (e.g. purchaser or merchant) using a fulfillment management system to improve the efficiency of the fulfillment process. As one example, when an order for an item is initiated, a commerce platform can create a fulfillment workflow for organizing data associated with the order and completing the fulfillment of the order. When a fulfillment workflow is created in connection with an order, there can be a large number of variables that require decisions by the purchaser or the merchant selling the purchased item. Examples of such variables include the type of packaging for shipping the order, the weight of the packaging with the ordered items, the shipping service for shipping the order, the type of shipping (e.g., expedited or standard), the costs associated with different types of shipping, the format of the shipping label, and whether to purchase insurance for the shipment. The decisions necessary to resolve the large number of variables can be overwhelming for the purchaser and/or merchant, thereby slowing down the completion of the order and the order fulfillment process. This problem is magnified for successful merchants who may be receiving, for instance, hundreds of orders per day. Furthermore, some decisions can have many options or choices. A large number of choices can increase the probability of an erroneous selection in the fulfillment workflow.

Erroneous selections, such as choosing oversized packaging or overlooking a less expensive shipping option, can result in unnecessary expense for the merchant or purchaser. Additionally, if a selection associated with a variable is erroneous and requires later correction with a manual override, such errors can slow down the fulfillment process. For instance, if a merchant selects a package size that is too small for shipping the purchased item, the error can propagate through the fulfillment workflow and require a manual override or correction by the fulfillment center. In other words, this type of error can impact how the purchased item will be gathered, packaged, and shipped from a fulfillment center. Fulfillment centers typically use workers and autonomous vehicles in a complex and highly efficient operation to gather purchased items and complete fulfillment workflows. In a typical day, fulfillment centers often complete hundreds or thousands of fulfillment workflows. Errors in the fulfillment workflow that require a manual override can disrupt the workers and autonomous vehicles at the fulfillment center, leading to inefficiencies. Accordingly, mechanisms that simplify the large number of variables to be addressed at the initiation of a fulfillment workflow can significantly improve the fulfillment process.

Prior approaches to resolving these challenges typically involve providing a static default setting in connection with values displayed in a user interface, such as a default shipping company. Such static default settings are of limited value because they are a one-size-fits-all solution to the problem. In other words, static defaults do not consider interrelated variables, such as how a type of package may affect shipping costs. As another example, static default settings are limited in that they do not consider historical data in determining the most useful default values to display in the user interface

An improved approach to managing fulfillment workflows provides dynamic default guidance or settings to a merchant or purchaser in arranging the packaging and shipping of an item being purchased. In connection with a new order, the merchant or purchaser can be presented with a user interface that displays one or more data elements of the fulfillment workflow for the new order (e.g. via a merchant device or purchaser/customer device). The e-commerce platform can compare the item in the new order to previous (historical) order data to identify similar previous orders. Such similar previous orders may be limited to those associated with the merchant or may include similar orders associated with other merchants. The e-commerce platform can use the previous order data to generate dynamic default selections for the fulfillment workflow for the new order. In this way, the e-commerce platform uses previous order data to optimize the guidance provided to the user through the fulfillment workflow for the new order.

One benefit with the default selections is that they can assist a merchant in more efficiently completing the required data to initiate the fulfillment workflow. More efficient completion of the required data for the fulfillment workflow allows the merchant to submit more orders for fulfillment and allows the fulfillment center to receive and complete orders more quickly. This improved efficiency can be of substantial benefit for a successful merchant that receives hundreds of orders per day.

Determining default values dynamically also allows the e-commerce platform to provide cost savings for the merchant. For example, shipping costs can be a substantial expense for the merchant and/or the purchaser. Reviewing recent historical order data for the merchant or other merchants can allow the e-commerce platform to identify the optimal package and shipping options for the order and present those options as one or more dynamic default values to the user. Furthermore, as more historical order data becomes available for a particular merchant over time, the greater historical data can be used to generate more accurate dynamic default values.

An additional benefit is that the default selections can guide the merchant to choose the correct selections, thereby reducing erroneous selections that require a later manual override. Reducing the number of manual overrides significantly impacts the efficiency of the fulfillment center that receives the fulfillment workflow. Avoiding manual overrides in the fulfillment workflow allows the fulfillment center's autonomous vehicles and workers to operate more efficiently. Given the substantial energy and computing resources used to operate the autonomous vehicles at a large fulfillment center, avoiding manual overrides in fulfillment workflows can provide substantial savings for these resources.

Accordingly, a fulfillment computing device or e-commerce platform that evaluates historical data to generate dynamic default values can make the fulfillment process more efficient. Such dynamic default values can identify selections that optimize cost savings and allow a merchant or purchaser to complete a fulfillment workflow more quickly. Dynamic default values also can assist in reducing errors in the fulfillment workflow thereby allowing the fulfillment process to be completed more efficiently.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

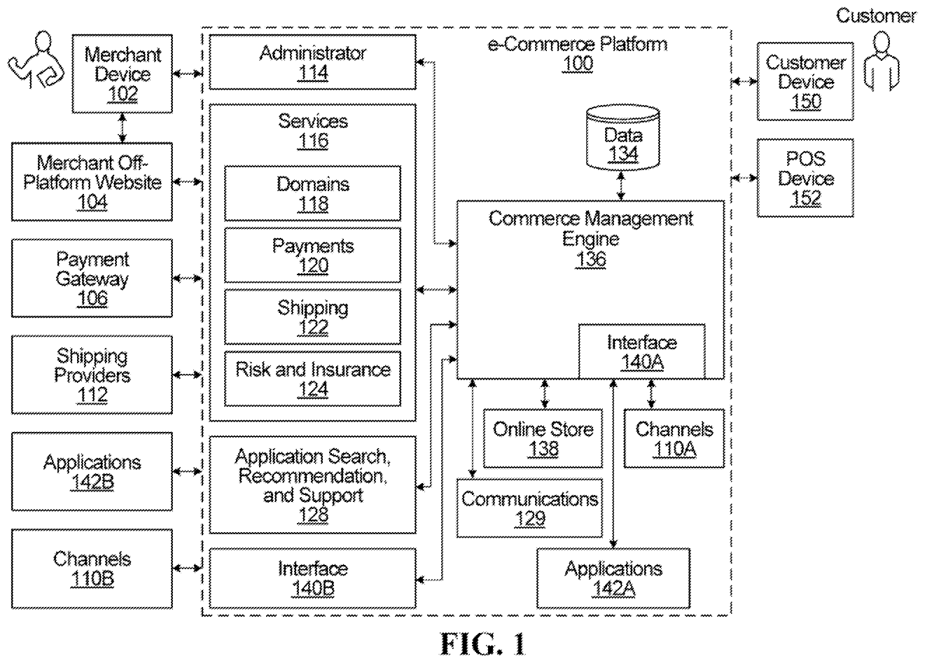

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform web site 104 (e.g., a commerce Internet web site or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their web site through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

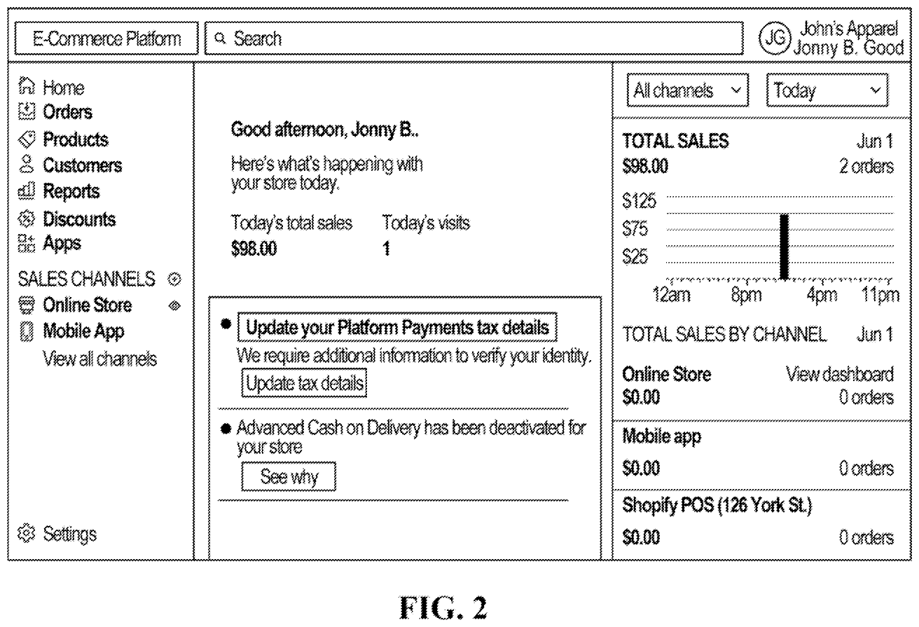

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component or engine (e.g., the commerce management engine 136 or shipping service 122). The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service (e.g. applications 142A-B) to send a fulfillment request externally for fullfillment by a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Providing Dynamic Default Values

As referenced previously, the functionality described herein may be used in commerce to provide improved merchant, customer, and/or purchaser experiences. The e-commerce platform 100 could implement the functionality via any of a variety of different components or applications. As one example, the functionality described herein can be implemented by the shipping service 122 described in connection with FIG. 1. Although the shipping service 122 is illustrated in FIG. 1 as a component of the e-commerce platform 100, in alternate embodiments the functionality described herein can be implemented with other software components residing within or external to the e-commerce platform 100. In some embodiments, either or both of the applications 142A-B provide a software module or engine that implements the functionality described herein to make it available to customers and/or merchants. Furthermore, in some embodiments, the commerce management engine 136 provides the functionality. However, the location of the software module or engine providing the functionality is implementation specific. Similarly, although the embodiments described below may be implemented in association with an e-commerce platform, such as (but not limited to) the e-commerce platform 100, the embodiments described below are not limited to e-commerce platforms.

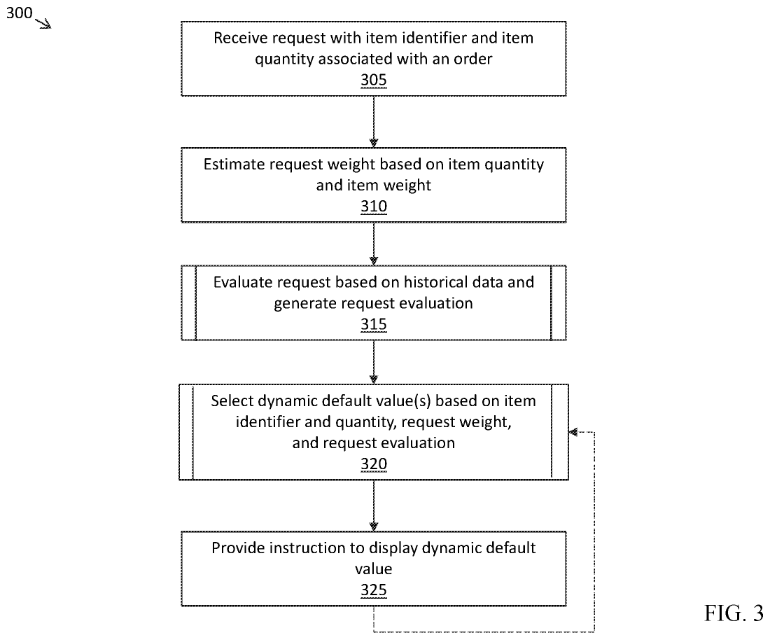

Referring now to FIG. 3, an example method 300 is illustrated for dynamically providing default selections or guidance in association with fulfilling an order. The operations of example method 300 and the other methods described herein can be implemented as a service or engine as described above or as computer-readable instructions executed by a fullfillment computing system or device, or any other processing facility such as those described above in connection with the components of the e-commerce platform 100. It should be understood that, in alternate embodiments, certain operations of method 300 and the other methods that follow can be combined or can be performed in a different sequence and, furthermore, other operations may be added to the example methods described herein.

Method 300 begins with operation 305 wherein a software module or engine, such as the shipping service 122 receives a request comprising an item identifier and an item quantity. The item identifier can be a product name, number, or a character string that identifies the product. The request can be associated with an order and can be received from a purchasing computing device that is associated with a merchant or a customer. In operation 310, the software module or engine can estimate a request weight calculated from the item identifier and the item quantity. For example, the shipping service can perform a look-up of the weight of the item in a data facility using the item identifier. Once a package is selected for shipping the item, the shipping service also can calculate a gross weight based on the sum of the request weight and the weight of the package. The weight of the package can include the weight of the outer portion of the package as well as any internal cushioning or support portions of the package. The shipping service can use the gross weight in determining the shipping options and shipping costs.

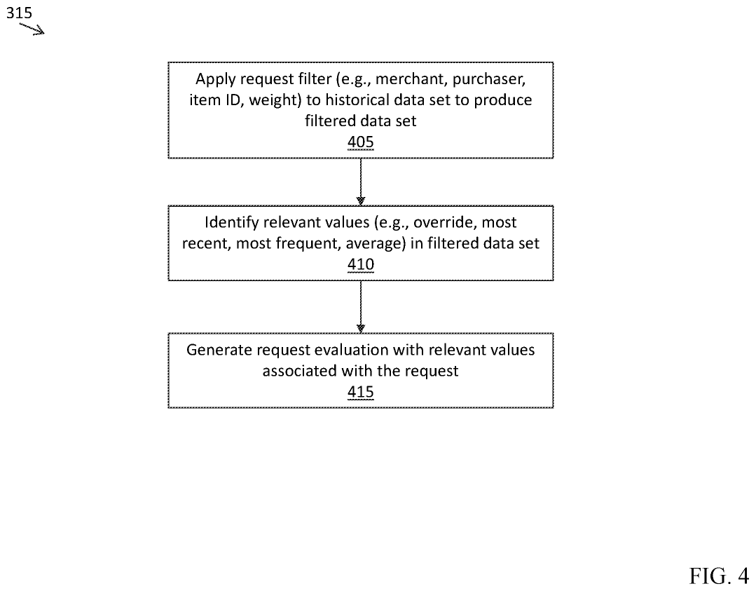

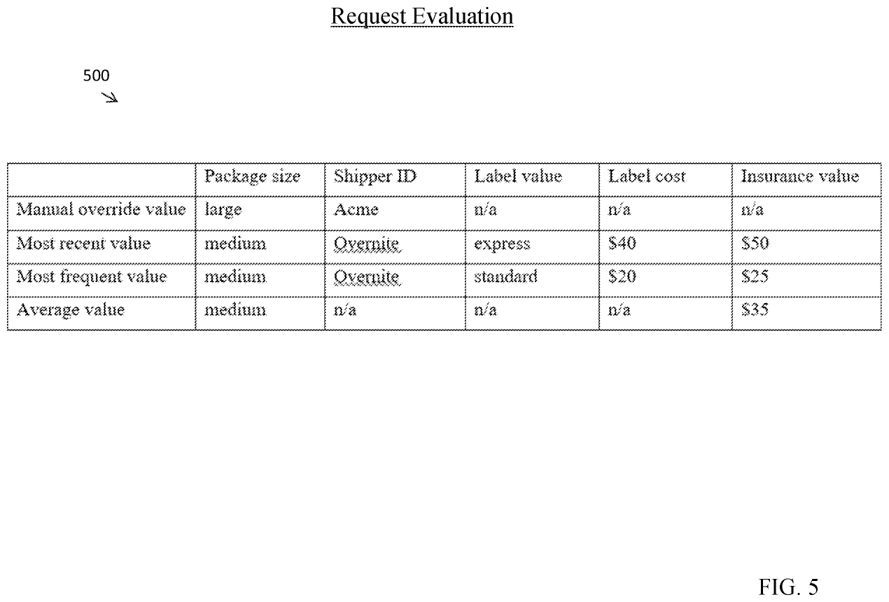

In operation 315, the shipping service evaluates the request based on historical data associated with previous orders. The previous orders can be associated with the same item identifier received in operation 305 so that they are relevant to the order associated with the request received in operation 305. In certain embodiments, the historical order data can be associated with the merchant supplying the ordered item, whereas in other embodiments the historical order data can be evaluated across multiple merchants offering the ordered item. The historical data can be stored in a data facility and made available to the shipping service for analysis. As will be described further below in connection with FIGS. 4 and 5, the shipping service evaluates the historical data to generate a request evaluation.

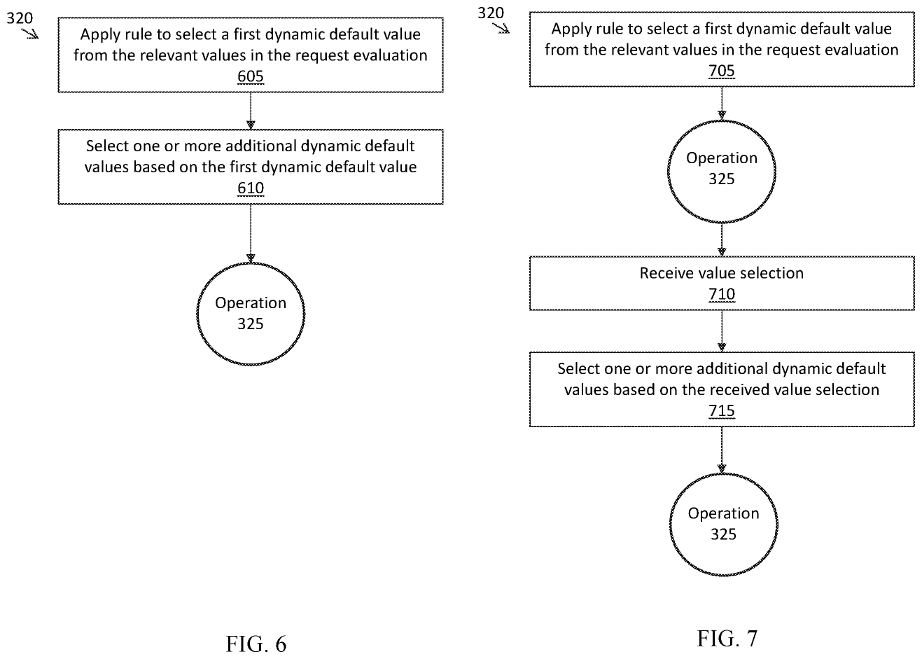

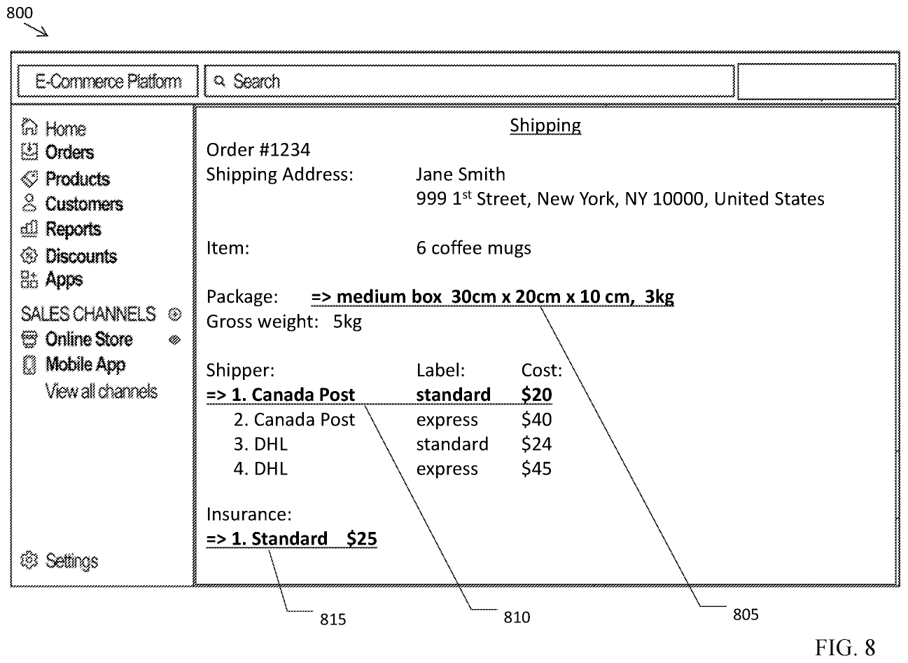

In operation 320, the shipping service uses the request evaluation to select dynamic default values that will guide the user through the fulfillment workflow. The dynamic default values can be based upon the received item identifier and quantity, the estimated request weight, and the generated request evaluation. Using these pieces of information, the shipping service can generate dynamic default values that are more useful than traditional static default settings. By evaluating recent historical data, the shipping service can select dynamic default values that are more relevant to the merchant's current operating conditions. For instance, during a busy holiday period, the merchant may have shipping preferences that differ from other periods of time when the flow of orders is slower. The selection of the dynamic default values will be described in greater detail in connection with FIGS. 6 and 7.

Lastly, in operation 325, the shipping service can provide an instruction to display the one or more dynamic default values selected in operation 320. For example, the shipping service can provide the display instruction to the e-commerce platform so that the dynamic default values are displayed in a user interface of the merchant or purchaser device. In one example, the user interface may be a webpage rendered by the e-commerce platform and transmitted to a fulfillment computing device (e.g. merchant device 102) or a purchaser computing device (e.g. customer device 150). In other examples, the display instructions can be sent to the fulfillment computing device or the customer computing device for rendering in a user interface.

In addition to the instruction to display the dynamic default values, the shipping service also can store the dynamic default values for use again in subsequent similar orders. As one example, the shipping service can store the dynamic default values and a weight (the estimated request weight and/or the gross weight) for use with subsequent orders comprising the same item identifier and item quantity. The stored dynamic default values and weight can also be used subsequently in a batch processing approach where multiple orders comprising the same item identifier and item quantity are processed at the end of a period of time.

Referring now to FIGS. 4 and 5, operation 315 will be described in greater detail. The method of FIG. 4 illustrates one non-limiting example for evaluating a request based on historical data to generate a request evaluation. Other examples for evaluating a request based on historical data can use a machine learning model that provides a prediction of the dynamic default values. Referring to the example of FIG. 4, in operation 405, the shipping service can apply a request filter to historical data in order to generate a filtered data set that is relevant to the request. The request filter can be based on one or more search criteria such as a merchant identifier, a purchaser identifier, an item identifier, a request weight, and a gross weight. The search criteria can be configured to tailor the filtered data set that is produced. In some cases, a merchant can specify the search criteria so that particular types of dynamic default values are generated. For instance, the merchant may want to use only historical data for prior orders associated with the same item identifier and quantity as the current order. As another example, if the merchant sells a class of products that are sold by a variety of merchants, the merchant may want to use historical data across a variety of merchants. As yet another example, if the merchant regularly receives large orders from a particular purchaser, the merchant may want to use only historical data associated with that repeat purchaser.

Once the filtered data set is produced, in operation 410, the shipping service can identify relevant values in the filtered data set. Examples of relevant values include the most recent values, the most frequent values, or the average values in the filtered data set. Another example of a relevant value is an instance of a manual override. In operation 415, the shipping service generates a request evaluation comprising the relevant values associated with the request. The request evaluation can be a data structure such as the one represented in FIG. 5. In the data structure 500 represented in FIG. 5, the columns are organized by types of values that can be selected as dynamic default values to be displayed as guidance in a user interface. The types of values illustrated in the representative data structure 500—package size, shipper identifier, label value, label cost, and insurance value—are non-limiting examples and other request evaluations can have fewer, greater, or different types of values. The rows of the example data structure are organized by relevance criteria, including a manual override value, a most recent value, a most frequent value, and an average value. As the names suggest the most recent value is the most recent value and the most frequent value is the value occurring most frequently among the filtered data set of the historical data produced in operation 405. With respect to the average value, certain types of historical data such as the shipper identifier are not amenable to being averaged. The manual override value may be of particular relevance because it indicates a value that was corrected in response to an erroneous selection. To illustrate, in the data structure 500, Overnite is the shipper identifier appearing most frequently in the filtered data set, but the manual override value of Acme for the shipper identifier suggests that Overnite may no longer be available as a shipper for the particular item and that Acme should be used as the default shipper.

As more orders are received and fulfilled over time, a greater amount of historical data can become available. The greater amount of historical data can be used to generate more accurate predictions of the dynamic default values. For example, the most frequent value for package size or shipper identifier in a large set of historical data is more likely to be an accurate dynamic default value than a most frequent value in a small data set. In certain examples, the predicted dynamic default values can be based upon recent historical data that is more relevant to the order than older historical data. For instance, weighting of more recent data or a sliding window that filters out older historical data can be used. In cases where a machine learning model is used, the historical data associated with previous orders (associated with the same or across multiple merchant accounts) can be used to train the model thereby producing more accurate predictions of dynamic default values. Greater accuracy in the dynamic default values increases the likelihood that the merchant or purchaser can accept the dynamic default values presented in the user interface thereby avoiding the need to make edits and expediting completion of the fulfillment workflow.

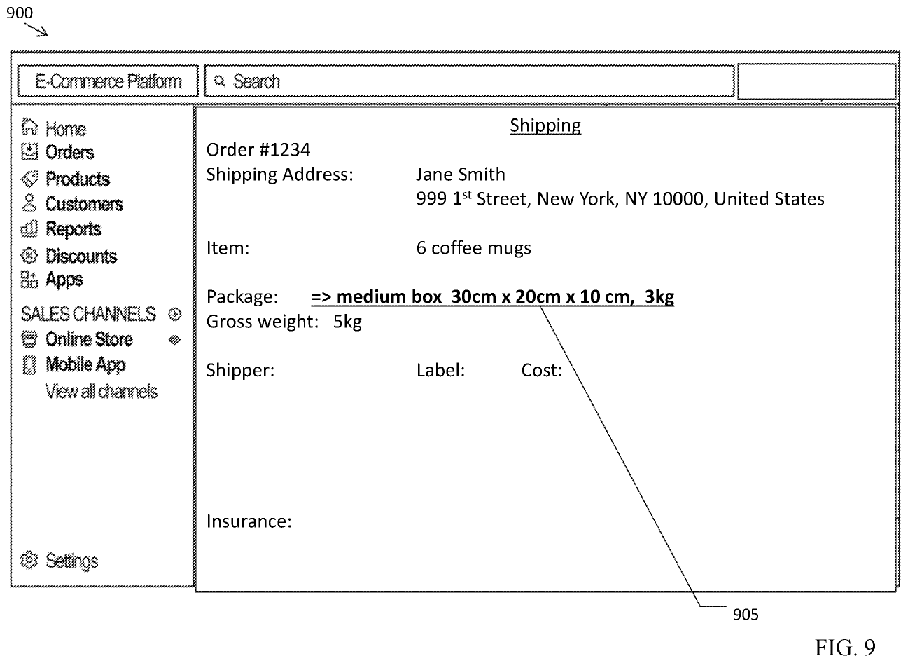

Referring now to FIGS. 6-9, operation 320 will be described in greater detail. Once the request evaluation has been generated from the historical data, the shipping service can select the dynamic default values that are to be displayed to guide the user. FIGS. 6 and 8 illustrate an example where multiple dynamic default values are selected and simultaneously displayed in the user interface. In contrast, FIGS. 7 and 9 illustrate an alternative example that is an iterative process where a first dynamic default value is displayed in the user interface and subsequently, responsive to receiving a selection, additional dynamic default values are displayed in the user interface.

Referring to FIGS. 6 and 8, in operation 605 the shipping service applies a rule to select a first dynamic default value from the relevant values in the request evaluation. The rule to be applied can be determined by the merchant. The rule can specify, for example, that the most recent values in the request evaluation are to be selected for the dynamic default values. Alternatively, the rule can specify that, where available, any manual override values should be selected as the dynamic default values. As another example, the rule can specify that the dynamic default values providing the most inexpensive costs should be selected. As yet another example, combinations of rules can be applied.

In operation 610, the shipping service selects one or more additional dynamic default values based on the first dynamic default value selection. For example, in some cases, the default values for the shipper, the label, and the label cost are dependent on the default value for the package size. Accordingly, a default value for the package size is selected before default values for the shipper, the label, and the label cost are selected.

After operation 610, the method returns to operation 325 where the shipping service provides an instruction to display the selected dynamic default values. As illustrated in the example of FIG. 8, the selected dynamic default values can be rendered in a user interface 800 to guide a user in completing the fulfillment workflow. The user interface displays data relevant to the fulfillment workflow. The example user interface 800 displays data received from the purchaser, including the order number, the shipping address, and the item being purchased. Additionally, the example user interface 800 displays the dynamic default values selected in operation 320, including the package size 805, the shipper identifier 810, and the insurance value 815. In the example user interface 800, the package size and the insurance value are displayed as single dynamic default values, whereas dynamic default values for the shipper, the label value and the label cost are displayed as an underscored choice among a plurality of shipper choices. In alternate embodiments, the dynamic default values can be displayed using other types of formatting, including, displaying the dynamic default value in bold font, in a font having unique color, with an arrow or other type of indicator, as the first choice in a list of choices, among other options.

Referring now to FIGS. 7 and 9, an alternative example of an iterative process is provided where a first dynamic default value is displayed in the user interface and subsequently, responsive to receiving a selection, additional dynamic default values are displayed in the user interface. In operation 705, the shipping service applies a rule to select a first dynamic default value from the relevant values in the request evaluation. Similar to operation 605, the rule can be determined by the merchant and the rule can direct the shipping service to select, for example, the most recent values, the most frequent values, the average values, or a manual override value in the request evaluation. In the example of FIGS. 7 and 9, the first dynamic default value can be package size and, referring to operation 325, this value can be displayed in the example user interface 900. Example user interface 900 displays data received from the purchaser, including the order number, the shipping address, and the item being purchased. Additionally, the example user interface 900 displays the package size 905 as the first dynamic default value selected in operation 705.

As illustrated in the example user interface 900, the first dynamic default value, which in this case is the package size 905, is displayed towards the top left corner of the user interface so that it will be among the first data items that the user reads when reviewing the fulfillment workflow data. In the instruction to display the first dynamic default value, the shipping service can include an instruction regarding the position in which the value should be displayed in the user interface. In one example embodiment that addresses the differences among languages that are read left to right and languages that are read right to left (e.g., Arabic or Hebrew), the shipping service can include an instruction to detect the reading direction of the language associated with the user interface and to position the first dynamic default value so that it will be among the first data items the user reads.

The method of FIG. 7 is an iterative approach that can be useful when subsequent dynamic default values are dependent upon the first dynamic default value. In the example of FIGS. 7 and 9, the subsequent dynamic default values for the shipper and insurance can depend upon the value of the package size. In operation 710, the shipping service can receive a value selection indicating whether the user accepted the dynamic default value for the package size or whether the user selected a different package size. In one example embodiment, the shipping service can use the request evaluation generated in operation 315 to provide further guidance in response to the value selection received in operation 710. For instance, if the value selection is for a package size that is too small and that received a manual override previously, the shipping service can provide an instruction to display a warning in the user interface that the value selection may be erroneous.

In operation 715, the shipping service can select one or more additional dynamic default values, such as the shipper identifier, the label value, the label cost, and the insurance value based upon the package size value selection received in operation 710. The iterative approach of FIG. 7 allows for greater accuracy because the value selection received from the user informs the selection of the additional dynamic default values. Greater accuracy with the additional dynamic default values increases the likelihood that the user can accept those default values without making edits and move through the fulfillment workflow more efficiently. Lastly, after operation 715, the method returns to operation 325 in which an instruction is provided to display the selected additional dynamic default values.

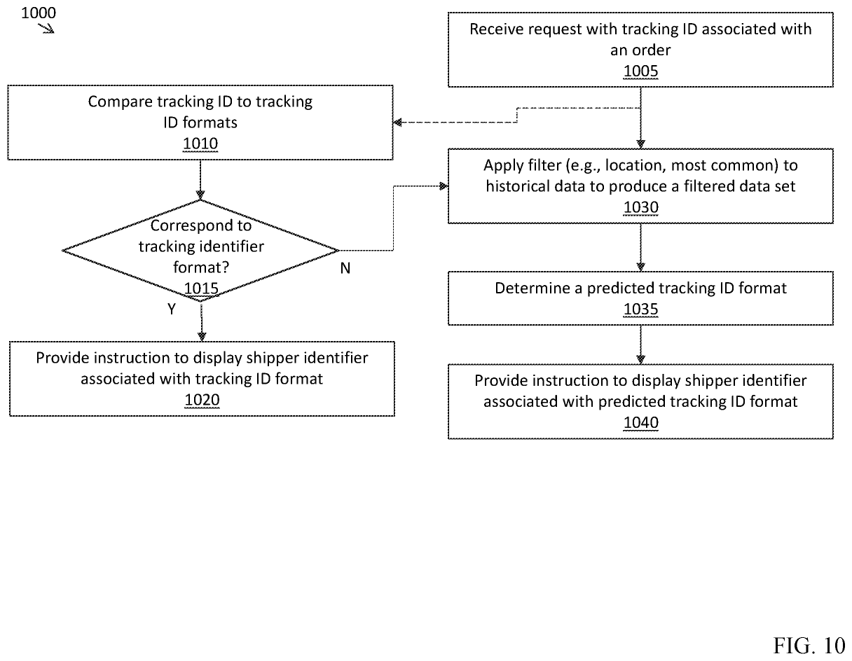

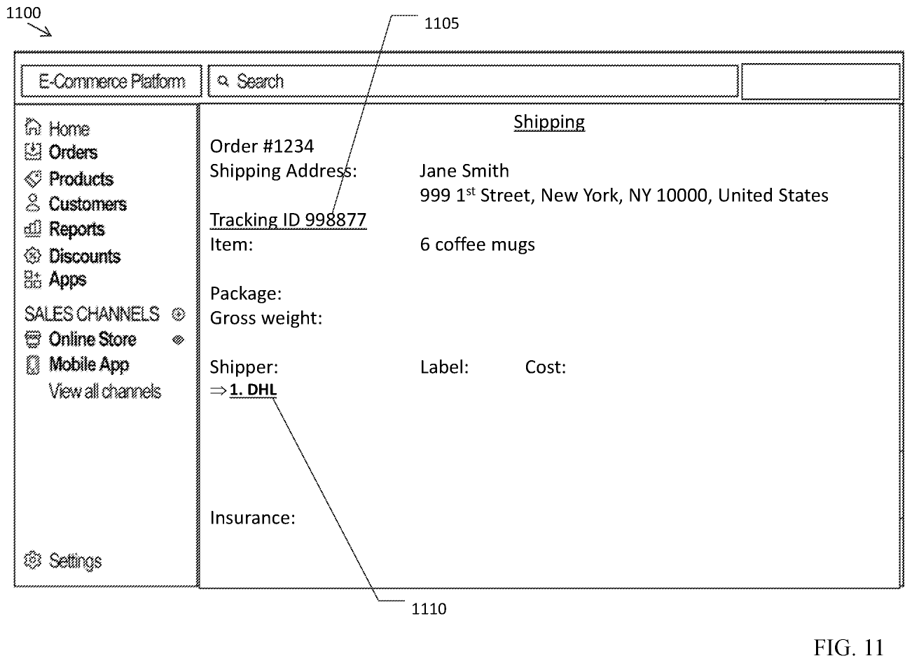

Referring now to FIGS. 10 and 11, an additional example embodiment focusing on a tracking identifier is described. The example embodiment of FIGS. 10 and 11 can be used in conjunction with the previously described functionality or as a stand-alone feature. In some cases, a merchant may have previously purchased shipping for the order and may have a tracking identifier to enter into the fulfillment workflow. Referring to example method 1000 of FIG. 10, in operation 1005, the shipping service receives a request and a tracking identifier associated with an order. Method 1000 can either perform optional operations 1010-1020 first, or method 1000 can forgo optional operations 1010-1020 and proceed directly with operations 1030-1040. Choosing optional operations 1010-1020, the shipping service can compare the received tracking identifier to available tracking identifier formats. For example, the available shippers may use unique tracking identifier formats allowing the shipping service to determine the shipper associated with the received tracking identifier based on the format. In operation 1015, if the shipping service determines that the received tracking identifier format corresponds with a shipper identifier, the shipping service can provide an instruction to display the shipper identifier associated with the corresponding tracking identifier format.

If in operation 1015 the shipping service is unable to determine a corresponding shipping identifier from the received tracking identifier format, or if the shipping service forgoes optional operations 1010-1020, the method proceeds to operations 1030-1040 where the shipping service will determine a predicted shipper identifier for use as a dynamic default value. In operation 1030, the shipping service can apply a filter to the available historical data to produce a filtered data set. The filter can be a location of the purchaser and a location-based shipper associated with the location wherein certain locations may have only one or a few available shippers. Alternatively, the filter can be a most common shipper used in previous orders associated with the historical data (from the same or across multiple different merchant accounts). In operation 1035, the shipping service can determine a predicted tracking identifier format by comparing the format of the received tracking identifier to the tracking identifier formats associated with shippers in the filtered data set. As one example, the predicted tracking identifier format can be the format that is consistent with received tracking identifier format and that appears most frequently in the filtered data set. Lastly, in operation 1040, the shipping service can provide an instruction to display the shipper identifier associated with the predicted tracking identifier format.

FIG. 11 illustrates an example user interface 1100 for a fulfillment workflow in connection with method 1000. The example user interface 1100 displays data received from the purchaser, including the order number, the shipping address, and the item being purchased. User interface 1100 also displays the tracking identifier 1105 received from the user in operation 1005. When operation 1040 is performed, the shipper identifier 1110 can be displayed as a dynamic default value in the user interface 1100 as illustrated in FIG. 11. Either in parallel with or after operation 1020 and operation 1040 of method 1000, other dynamic default values can be determined and displayed in the user interface in accordance with the previously described functionality of FIGS. 3-9. As describe previously, the dynamic default values are more accurate than traditional static default settings because they utilize valuable historical information that can be regularly updated. Providing dynamic default values that are more accurate than traditional static default settings allows the user to complete the data for the fulfillment workflow more efficiently and provides opportunities to avoid unnecessary expenses. The more accurate dynamic default values also improve the processes at a fulfillment center by reducing erroneous data in the fulfillment workflow that may require a manual override.

### Terminology And Understandings

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain operations of the methods may be performed in a different order, may be performed in parallel, or may be omitted. Moreover, in alternate embodiments additional operations may be added to the example methods described herein. Accordingly, the example methods provided herein should be viewed as illustrative and not limiting of the disclosure.

Terms such as “first” and “second” are used merely to distinguish one element or operation from another. Such terms are not meant to denote a preference or a particular order, and are not meant to limit the embodiments described herein. In the example embodiments described herein, numerous specific details are set forth in order to provide a more thorough understanding of the disclosure. However, it will be apparent to one of ordinary skill in the art having regard to the present application that the embodiments may be practiced without these specific details. In other instances, well-known features have not been described in detail to avoid unnecessarily complicating the description.

As used herein, the terms “a,” “an,” and “the” are intended to include plural alternatives, e.g., at least one. The phrase “and/or” means either or both. Similarly, when used in a list of items, the word “or” means either or both. However, when “or” is preceded by “either” or similar terms, it shall be interpreted as meaning exclusive alternatives. The terms “including”, “with”, and “having”, as used herein, are defined as comprising (i.e., open language), unless specified otherwise.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Although embodiments described herein are made with reference to example embodiments, it should be appreciated by those skilled in the art having regard to the present application that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A computer-implemented method comprising:
receiving a request associated with an order and comprising an item identifier and an item quantity;
estimating a request weight for the request based on the item quantity and an item weight associated with the item identifier;
evaluating the request based on historical data associated with previous orders associated with the item identifier to generate a request evaluation;
selecting a dynamic default value for the request based on the item identifier, the item quantity, the request weight, and the request evaluation; and
providing an instruction to a fulfillment computing device to display the dynamic default value.

2. The computer-implemented method of claim 1, wherein the dynamic default value is one of a shipper identifier, a package size, a label value, and an insurance value.

3. The computer-implemented method of claim 1,
wherein the request evaluation identifies from the historical data one of: a manual override value, a most frequent value, an average value, and a most recent value; and
wherein the dynamic default value is selected from the manual override value, the most frequent value, the average value, and the most recent value.

4. The computer-implemented method of claim 1, wherein evaluating the request based on the historical data associated with the previous orders comprises:
identifying similar previous orders among the previous orders of the historical data, wherein the similar previous orders are associated with a same request weight as the request weight;
identifying a previous value among the similar previous orders; and
selecting the previous value as the dynamic default value.

5. The computer-implemented method of claim 4, wherein the previous value is one of: a manual override value, a most frequent value, an average value, and a most recent value.

6. The computer-implemented method of claim 1, wherein evaluating the request based on the historical data associated with the previous orders comprises:
identifying similar previous orders among the previous orders of the historical data, wherein the similar previous orders are associated with a same item identifier as the item identifier of the request and a same item quantity for the same item identifier as the item quantity of the request;
identifying a previous value based on the similar previous orders; and
selecting the previous value as the dynamic default value.

7. The computer-implemented method of claim 1, further comprising:
calculating a gross weight based on the request weight and a weight associated with a dynamic default package size; and
providing an instruction to a purchasing computing device to display the dynamic default package size and the gross weight simultaneously.

8. The computer-implemented method of claim 7, further comprising:
storing the dynamic default package size and the gross weight for batch processing of a plurality of additional requests for fulfillment comprising a same item identifier and a same item quantity.

9. The computer-implemented method of claim 7, wherein providing an instruction to the fulfillment computing device to display the dynamic default package size and the gross weight simultaneously includes an instruction to the fulfillment computing device to display the dynamic default package size and the gross weight in a position selected based on an expected reading direction of a user interface language of the fulfillment computing device.

10. The computer-implemented method of claim 7, further comprising:
identifying a least expensive shipping option among the plurality of shipping options based on the gross weight; and
providing an instruction to the fulfillment computing device to display the least expensive shipping option.

11. The computer-implemented method of claim 10, further comprising providing an instruction to the fulfillment computing device to display the least expensive shipping option simultaneously with the dynamic default package size and the gross weight.

12. The computer-implemented method of claim 7, further comprising:
generating a label in response to a selection of a shipping option from among a plurality of shipping options;
comparing the label to historical shipping insurance data;
selecting a dynamic default shipping insurance for the request based on the item identifier, the item quantity, the request weight, the label, and the historical shipping insurance data; and
providing an instruction to the fulfillment computing device to display the dynamic default shipping insurance.

13. The computer-implemented method of claim 1, further comprising:
receiving a tracking identifier associated with the request;
applying a filter to the tracking identifier,
determining a predicted tracking identifier format of the plurality of tracking identifier formats, and
providing an instruction to the fulfillment computing device to display a predicted shipper identifier associated with the predicted tracking identifier format.

14. The computer-implemented method of claim 13, wherein the filter comprises a location of a purchaser associated with the order and a location-based shipper associated with the location.

15. The computer-implemented method of claim 13, wherein the filter comprises a most common shipper based on the historical data.

16. A computing system comprising:
one or more computer processors; and
a memory having instructions stored therein that, when executed by the one or more processors, cause the one or more processors to perform operations comprising:
receiving a request associated with an order and comprising an item identifier and an item quantity;
estimating a request weight for the request based on the item quantity and an item weight associated with the item identifier;
evaluating the request based on historical data associated with previous orders associated with the item identifier to generate a request evaluation;
selecting a dynamic default value for the request based on the item identifier, the item quantity, the request weight, and the request evaluation; and
providing an instruction to a fulfillment computing device to display the dynamic default value.

17. A non-transitory computer-readable medium having instructions stored thereon that, when executed by one or more computer processors, cause the one or more computer processors to perform operations comprising:
receiving a request associated with an order and comprising an item identifier and an item quantity;
estimating a request weight for the request based on the item quantity and an item weight associated with the item identifier;
evaluating the request based on historical data associated with previous orders associated with the item identifier to generate a request evaluation;
selecting a dynamic default value for the request based on the item identifier, the item quantity, the request weight, and the request evaluation; and
providing an instruction to a fulfillment computing device to display the dynamic default value.

18. The non-transitory computer-readable medium of claim 17,
wherein the request evaluation identifies from the historical data one of: a manual override value, a most frequent value, an average value, and a most recent value; and
wherein the dynamic default value is selected from the manual override value, the most frequent value, the average value, and the most recent value.

19. The non-transitory computer-readable medium of claim 17, wherein evaluating the request based on the historical data associated with the previous orders comprises:
identifying similar previous orders among the previous orders of the historical data, wherein the similar previous orders are associated with a same request weight as the request weight;
identifying a previous value among the similar previous orders; and
selecting the previous value as the dynamic default value.

20. The non-transitory computer-readable medium of claim 17, wherein evaluating the request based on the historical data associated with the previous orders comprises:
identifying similar previous orders among the previous orders of the historical data, wherein the similar previous orders are associated with a same item identifier as the item identifier of the request and a same item quantity for the same item identifier as the item quantity of the request;
identifying a previous value based on the similar previous orders; and
selecting the previous value as the dynamic default value.
